(19) United States
(12) Patent Application Publication
(10) Pub. No.: US 2001/0029465 A1
(43) Pub. Date: Oct. 11, 2001

(54) System and method for processing and displaying product information on a computer

(76) Inventor: John Strisower, Chico, CA (US)

Correspondence Address: William G. Goldman, GRAY CARY WARE & FREIDENRICH, Attn: Patent Group, 3340 Hillview Avenue, Palo Alto, CA, 94304, US

(21) Appl. No.: 09/792,486

(22) Filed: Feb. 23, 2001

Related U.S. Application Data
(60) Provisional application No. 60/184,735, filed on Feb. 23, 2000.

(51) Int. Cl. G06F 17/60

(52) U.S. Cl. 705/14

(57) ABSTRACT

The invention provides a useful method and apparatus for processing and displaying product information over a computer network such as the Internet. Using computer executable software, the invention is able to receive graphics files and corresponding database information related to a product and store the information in a format that can be easily searched. Different layers of information pertaining to the product may be stored and cross referenced so that products can be researched by price, quality, location and other factors that may be important to the consumer. All information traditionally conveyed by FSIs can be emulated. Furthermore, the invention provides the added benefit of cross referencing the information pertaining to the product including advertiser information (store location or WWW address), date range of the advertisement (e.g. expiration date), product description, price, name brands, and other useful information.

The invention relates generally a system and method for processing displaying advertising information on a computer network and, more particularly, relates to processing and displaying product pricing and distribution information over the Internet.

### BACKGROUND OF THE INVENTION

In retail advertising, a common method of advertising is to place free standing inserts (FSIs) into newspapers. These FSIs typically include local retail shopping information including pictures of products, prices and advertiser's retail locations where the products are sold. The information is very useful to consumers who wish to obtain general information on products before venturing out on a shopping trip. They are also useful to advertisers for capturing large audiences for advertising product information, special price opportunities and local distribution location information. Using FSIs, consumers can be reached in specific local areas, providing useful information for the retail shopper. Using these circulars, a consumer can search out and find a specific product, where it can be purchased, and its price, possibly from a variety of sources. There are, however, obvious problems related to using these inserts in newspapers.

Newspaper circulation is currently in the tens of millions. Adding in advertisements, many of which are not recyclable, creates a great deal of trash that requires disposal. Moreover, many of these circulars are not even read by consumers and are simply discarded. This is clearly not responsible use of natural resources.

Furthermore, newspaper circulation is on the decline as a result of the Internet. More people are shopping online for items, and are accessing websites containing product order information from locations all over the world. In the future, the audience for online shopping will also continue to grow, further obviating the need for distribution of paper advertising. However, even with the growth in the use of the Internet, there is currently no source for local retail advertising that emulates the FSIs that appear in popular newspapers.

Many websites exist for shopping and ordering products online. However, there still exists a large market for shopping at malls and shops. And, no sites exist that truly emulate FSIs. It would be useful to be able to disseminate the information traditionally found in the FSIs over the Internet. It is to this end that the present invention is directed.

### SUMMARY OF THE INVENTION

The invention provides a useful method and apparatus for processing and displaying product information over a computer network such as the Internet. Using computer executable software, the invention is able to receive graphics files and corresponding database information related to a product and store the information in a format that can be easily searched. Different layers of information pertaining to the product may be stored and cross referenced so that products can be researched by price, quality, location and other factors that may be important to the consumer. All information traditionally conveyed by FSIs can be emulated. Furthermore, the invention provides the added benefit of cross referencing the information pertaining to the product including advertiser information (store location or WWW address), date range of the advertisement (e.g. expiration date), product description, price, name brands, and other useful information.

In an aspect, an electronic system providing a plurality of digital free standing inserts, comprises an imaging application for receiving a pre-print free standing insert and for rendering a digital rendition of the pre-print free standing insert. The imaging application includes an embedded tool for selecting portions of the digitally rendered pre-print free standing insert. The system also comprises an advertisement creation application for capturing information relating to each of the advertisements depicted in the digital rendition of the pre-print free standing insert. The information is stored in a database. An image server is provided for rendering the captured information as one or more webpages, each webpage depicting a digital rendition of a particular pre-print free standing insert. A selection tool allows a user to locate particular ones of the digitally rendered pre-print free standing inserts. The digitally rendered pre-print free standing inserts are locatable in accordance with geographic particularity. A user can search among a plurality of digitally rendered free standing inserts to locate particular advertisements. Advertisements may be locatable in accordance with any of predefined product categories, brand categories, and store categories. Further, the digitally rendered pre-print free standing inserts are processed by an image mapping algorithm to create for each individual advertisement a hotspot area such that when a particular hotspot area is accessed by the user additional information relating to that associated advertisement is displayed to the user.

In another aspect, the invention affords a method for creating a digital rendition of a pre-print free standing insert, comprising the steps of: digitally rendering a pre-print free standing insert; extracting individual graphic and text portions of the digitally rendered pre-print free standing insert, the graphic and text portions relating to individual advertisements on the pre-print free standing insert; and performing an image mapping process on the digitally rendered pre-print free standing insert to associate a hotlink image boundary with respective advertisements on the digitally rendered pre-print free standing insert.

The method further comprises the steps of creating one or more webpages with the digitally rendered pre-print free standing insert and displaying the webpages to a user, and associating additional information relating to each of the respective advertisements on the digitally rendered pre-print free standing insert, and presenting the additional information when the associated hotlink image boundary is accessed.

### BRIEF DESCRIPTION OF THE DRAWINGS

FIG. 1 is a block diagram illustrating a system configured to create and view advertisements according to the invention;

FIG. 2 is a flow diagram illustrating exemplary general steps used to create a digital rendition of a free-standing advertisement insert according to the invention;

FIGS. 3A and 3B are respective exemplary screenshots of an aspect of the ad creation software application shown in FIG. 1;

FIG. 4 is an exemplary screenshot illustrating selection of portions of the digitally rendered free-standing insert in accordance with the invention;

FIGS. 5A and 5B are respective exemplary screenshots showing free-standing insert data being entered into the system via a user interface;

FIG. 6 is an exemplary screenshot illustrating the creation of hotspot regions on a digitally rendered free-standing insert in accordance with the invention;

FIG. 7 is an exemplary screenshot of a webpage that may be displayed to a user that allows the user to select and search a variety of free-standing insert advertisements in accordance with the invention; and

FIG. 8 is an exemplary screenshot of a webpage that may be displayed to a user that displays several thumbnail images of digitally rendered free-standing insert advertisements that may be individually selected by a user.

### DETAILED DESCRIPTION OF THE PREFERRED EMBODIMENT

The invention generally pertains to a method and apparatus for enabling advertising on a computer network in a manner that emulates a FSI traditionally used in newspaper advertising. However, it will be appreciated by those skilled in the art, that this is illustrative of only one utility of the invention, and that the invention has greater applicability and utility in many other applications where the use of searchable advertising is involved. Equivalent structures and functions embodying the invention could be configured for other such applications without diverting from the spirit and scope of the invention as defined in this disclosure.

Generally, digital images (i.e., advertisement presentations) can be created and stored in an electronic file for use in a computer network. An image may be created, for example, by an advertiser or retailer and may depict information related to a particular product for sale. This information may include advertiser information, store location, a store website address, the date range for “running” the free-standing insert advertisement on a webpage, the date range of individual ads or special offers associated with the image, product description and price information, name brands, and other usable information that a consumer may want to know about a product.

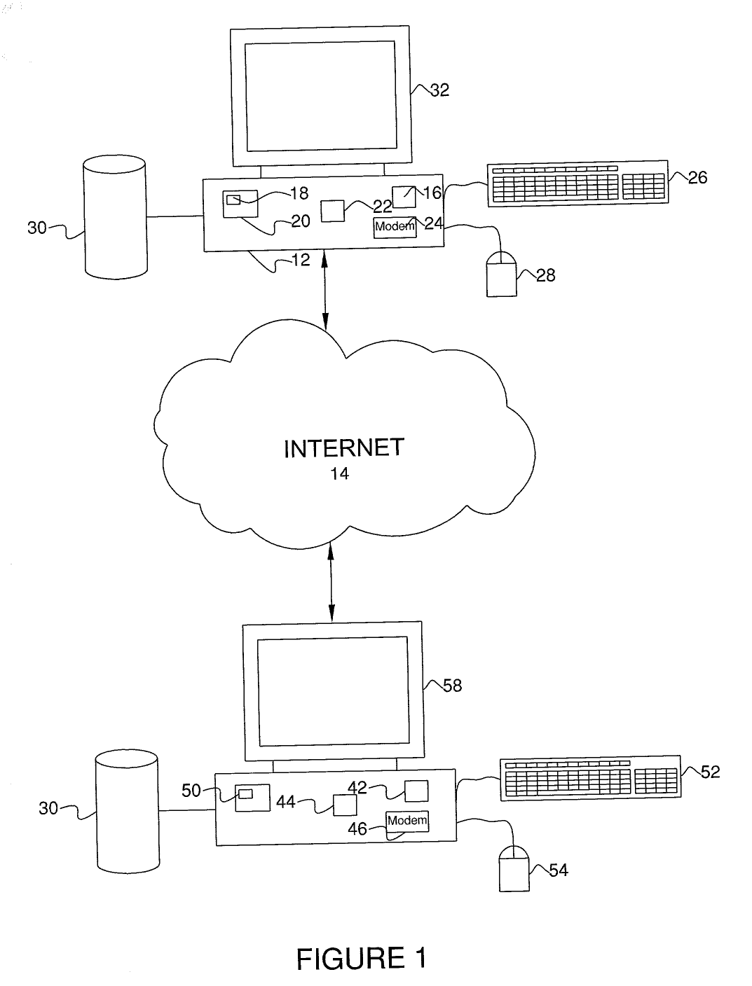

The graphics file may be created on a computer 12 connected to a network system 14 that is configured to process digital images stored in graphics files. Referring to FIG. 1, an exemplary system 10 is illustrated. A graphics file representing, for example, an advertiser's ad may be created on a computer 12 which may include a CPU 16 for controlling the operation of the computer 12. The computer 12 may have an advertisement creation software application 18 stored in a memory 20 therein. The computer 12 may further include a cache memory 22 for storing frequently used information to be processed by the CPU 16. A modem 24 or similar communications device may connect the computer 12 to the network 14 and configured to transmit signals between the computer 12 and the network 14 to send, receive and store graphics files and other information. A user may interact with the computer 12 via a keyboard 26 or a mouse 28 or other equivalent interfacing means, and one or more databases 30 may be associated with the computer 12. A graphical user interface (described below) may be displayed to a user via a monitor 32 or other display means.

A user wishing to view advertisements or otherwise interact with the network 14 may access the network 14 via a computer 40. The computer 40 may be similar to the computer 12 used to create a digital advertisement and may include a CPU 42 for controlling the operation of the computer 40. The computer 40 may further include a cache memory 44 for storing frequently used information to be processed by the CPU 42. A modem 46 or similar communications device may connect the computer 40 to the network 14 and be configured to transmit signals between the computer 40 and the network 14 to send, receive and store graphics files and other information. The computer 40 may also include a memory 48 configured to store, a web browser application 50 enabling a user to access the Internet 14 via the modem 46 or other communications device using the computer 40. A user may interact with the computer 40 via a keyboard 52 or a mouse 54 or other equivalent interfacing means, and one or more databases 56 may be associated with the computer 40. A graphical user interface (described below) may be displayed to a user via a monitor 58 or other display means to enable the user to interact with the computer 40 and the network 14.

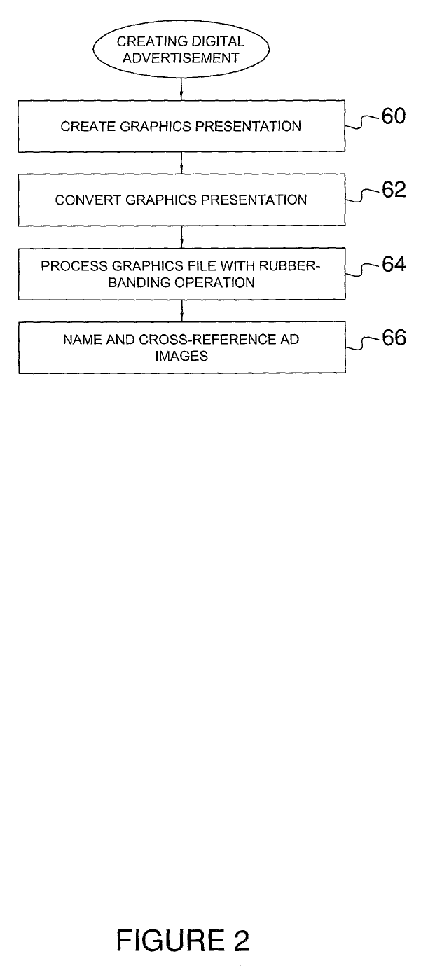

Referring to FIG. 2, a general overview of a process for creating digital advertising information in accordance with the invention is illustrated by a flow chart of operations. The first step 60, creating a graphics presentation, may be accomplished, for example, by a user interacting with the graphics application 18 stored in the memory 20 of the computer 12 (FIG. 1) for uploading a graphics file into the graphics application 18 for processing in accordance with the invention. The next step 62, involves converting the graphics presentation into a graphics file preferably of a uniform format.

For example, the original FSI image may be created as a PDF image file (or other image file type) and preferably converted to a Windows Bitmap file of approximately the same pixel width and original file aspect ratio. Those skilled in the art recognize that other file types may include JPEG or GIF files instead of BMP files. The smaller Windows-based files may then be used as the input graphic file for the ad creating software application 18. Still referring to FIG. 2, the next step 64 in the process may be to separate and isolate individual regions (known as “rubber-banding”) of the graphic file to create clipped pieces of the original image file that are used by the system as independent ad graphic files. This process creates a highly optimized file of the ad region as a separate graphic and also can create one or more “hot-spot” regions or outline coordinate areas associated with the original image that can be used as coordinates of an image map (explained below). This allows a user when accessing a resulting advertisement webpage via the Internet, to drag and click the user's mouse pointer anywhere over the webpage, and details of each ad will appear in other areas of the screen in response to the user moving the mouse pointer over the particular image mapped regions. Separate database records can be created for each ad based upon data contained in the separated or “rubber-banded region” as will be described below.

The file images may be stored on image servers with path/file names associated with database records for each individual product ad and each store ad. As a user accesses different records of the database, the files are retrieved based upon their file names by accessing the image servers. In a preferred embodiment, the original file is converted into a Microsoft Windows-compatible bitmap (BMP) file and may be converted with a resolution of 72 dpi (or other) to provide visual clarity. Information relating to the graphics files are also stored in the database 30. For example, these graphics files can include certain product images and other graphical user interface images that can be used and reused in creating advertisements. For example, a pair of shoes of a particular design and make can be used by multiple advertisers that may offer the same product. Similarly, certain advertisers may have a certain format for their ads that give a consumer a familiar look and feel for their style of advertising. Attributes such as background color, text designs, page organization, and other attributes can be captured and stored in certain files and reused in different advertisements over time. Once files are converted into a universal format, a user can incorporate textual information relating to the advertisement images (Step 64 in FIG. 2). This feature is described in more detail below. A user can then name and cross reference ad images in step 66 to complete a digital advertisement of an FSI.

Thus, in general, graphics and other information, such as product pictures and textual information, may be extracted from pre-print media and image map coordinates for graphical navigation may be associated with the extracted graphics. The pre-printed media may then be uploaded to the Internet and a user may access the images and obtain additional information about the various advertisements.

In operation, a user creating a digital advertisement, for example by using the computer 12 (FIG. 1) may utilize the advertisement creation software application 18 to create a digital advertisement from an FSI. Upon accessing the software application 18, the user may be prompted to upload a graphics file of an FSI. This image may be stored in the memory 20. The image may also be stored in the database 30 for future use. Accordingly, the stored information enables the system 10 to utilize pre-configured advertiser images in an advertisement. This way, a user can quickly develop an ad by simply changing the product images, prices and store locations.

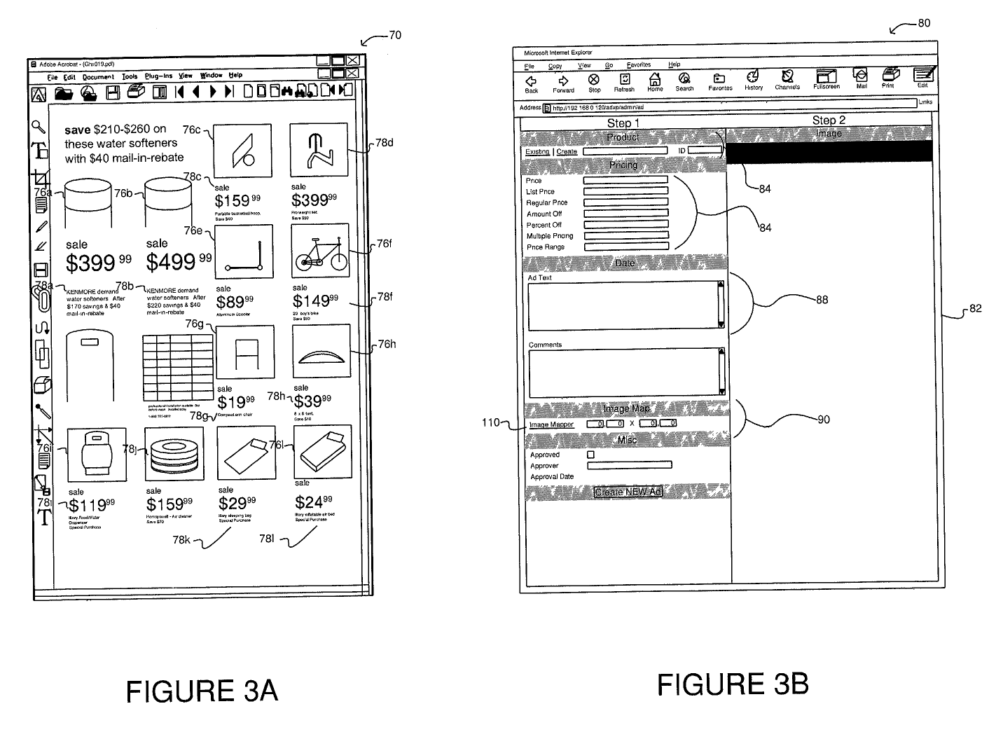

FIGS. 3A and 3B are respective exemplary screenshots of an aspect of the ad creation software application 18. Specifically, FIG. 3A shows an exemplary screenshot 70 of an Adobe Acrobat application 72 that is capable of viewing and manipulating PDF type files that represent a pre-print FSI advertisement. The PDF files may be scanned or otherwise uploaded to the system 10. While Adobe Acrobat is illustrated, those skilled in the art will recognize that other file types and applications may be used without departing from the invention and the above is merely exemplary. The pre-print advertisement 74 shown in FIG. 3A has twelve unique advertisement items 76aI, each shown with an associated portion of text 78a-1 relating to those advertisements 76aI. The text 78aI may indicate the cost of the items, and other descriptive information about the items.

FIG. 3B is an exemplary screenshot 80 of a user interface 82 (part of the ad creating software application 18) that may be used to input digital advertisement data relating to the FSI advertisement into the system. The user interface 82 may include different data fields for indicating information about the digital FSI advertisement(s). For example, product information 84 may be entered into appropriate data fields. Pricing information 86, such as price, list price, regular price, amount off, percent off, multiple pricing, and other information may also be entered into the appropriate data fields. Ad text 88 may also be entered into the system, and an image map 90 may be created for the image. These features will be described below in more detail below.

An image file representing a pre-print FSI advertisement may be initially created, for example by a retailer, as a Quark file, a PDF file, or other file format, and may be processed using a PC, Macintosh, or other similar computer system. Preferably, image files are output as PC compatible PDF files using Adobe Acrobat 4 running on a Microsoft Windows 2000 server; however, other environments may be used. Generally, in operation, a retailer or advertiser may provide FSI data via the network 14 or via removable media that may be integrated with the computer 12. If the retailer provides the FSI data in an Apple format, for example, the information may be converted to PC compatible file formats, but this is not necessary to practice the invention.

The FSI data (i.e., FSI pages, ad date parameters, store locations, etc.) may be input into the system 10 either automatically or by an operator. As described above, an appropriate folder, directory, or other sorting ontology may be used to store the FSI data in the database 30, and a script may be executed by the ad creation software application 18 that creates a file structure which organizes the graphical and data elements of each digitally constructed FSI page, storing this information in associated subdirectories. This information may be stored in an SQL (or other type) database 30. Preferably, the information may be stored on a Microsoft SQL server. The FSI data may be converted to a JPG (or other type) format, for example by executing an appropriate batch script. The converted JPG images may be stored in the associated folders described above.

Digital advertisements of the FSI advertisements may then be created in accordance with the invention. By utilizing the stored FSI image files and FSI data information about the advertisements, database records can be created containing advertisement detail information and corresponding images. To create a digital advertisement, a user may access the PDF (or other type) image file displayed in the Adobe Acrobat (or other) window (FIG. 3A), and may select one of the images shown on the pre-printed page. Preferably, the Adobe Acrobat (or other) application includes an embedded selection tool, such as BCL Computer's Jade application. Jade is a plug-in application for Adobe Acrobat that allows users to accurately extract data from Adobe PDF files that would otherwise be unobtainable. It allows text, tabular data, and graphics contained in PDF files to be edited and manipulated in other Windows applications. Advantageously, native PDF documents can be zoned and the data accurately extracted via a conventional drag-and-drop operation into other applications. Graphic zones can be used to create BMP (or other ) files or clipboard images with any user-defined resolution and color depth. The result can then be pasted to any image-enabled authoring product with an intuitive drag and drop, copy paste or export to file interface. Similarly, the text or table in a zone can be extracted directly to a file, or to the Windows clipboard (copy-and-paste). For character formatting, Jade maintains or maps fonts, font style, font size, text color, and superscripts. Jade also preserves background and foreground colors, while removing hidden text and overstrike text. Thus, using this sort of plug-in tool, the data from the FSI inserts may be selected and extracted from the original file and saved as individual files to the system 10. These files can be assembled as web pages that a user accessing the Internet 14 may interact with and receive various information relating to the digital advertisement.

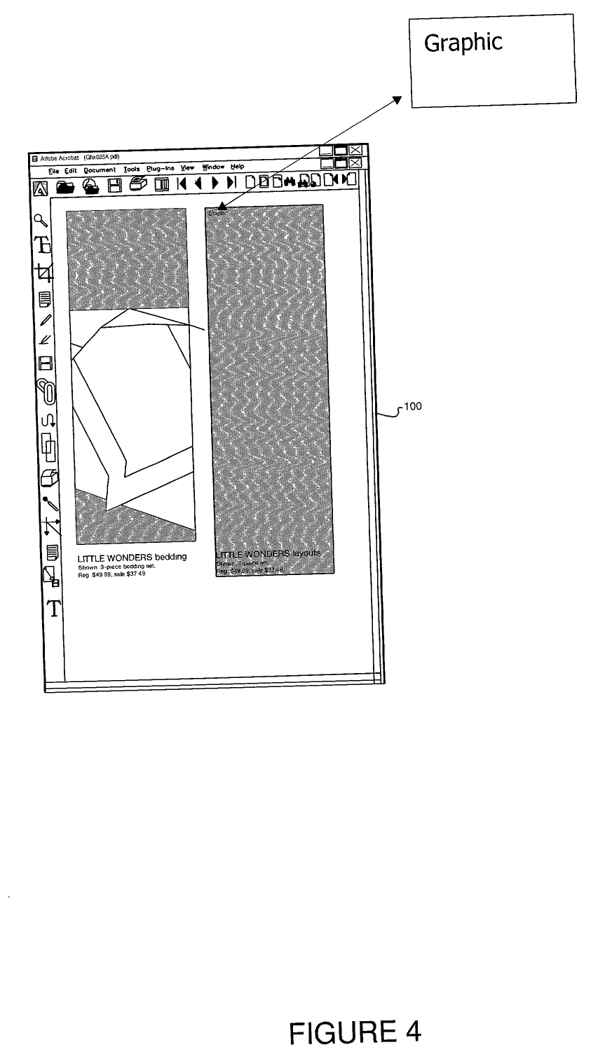

For example, using the Adobe Acrobat (or other) interface, a user may select an advertisement image and associated text from the pre-print media FSI advertisement by, for example, enabling the Jade plug-in tool, and dragging the mouse over the desired portion of the image that the user wishes to select. This is shown in FIG. 4 as a highlighted rectangular box 100 surrounding the “Little Wonders” layette advertisement 102a. This advertisement 102a or portions thereof may be extracted from the FSI advertisement and stored in the system 10 to be incorporated into the digital rendition of the advertisement.

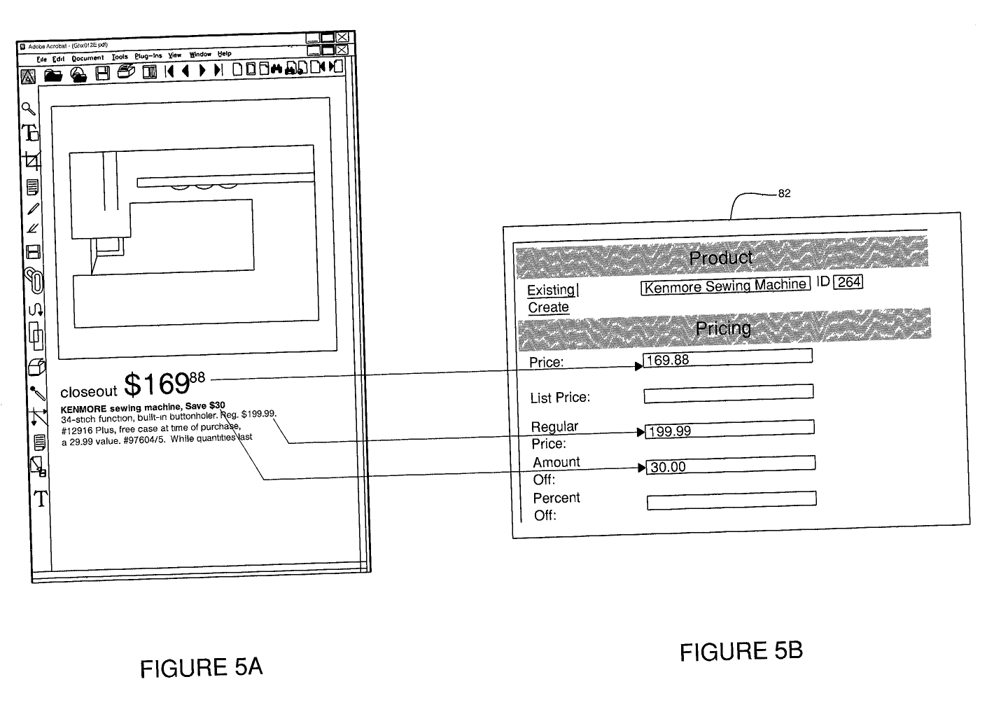

The above example is illustrated in more detail in FIGS. 5A and 5B which show selected FSI data being entered into the system via the user interface 82. In FIGS. 5A and 5B the example is illustrated with respect to a “Kenmore” sewing machine FSI advertisement. The user may review the text associated with the FSI advertisement image (FIG. 5A) and may enter portions of that text into appropriate data fields in the user interface shown in FIG. 5B. Noting the text in the FSI advertisement shown in FIG. 5A, the “Kenmore” sewing machine is priced at $169.88. The user may enter that information into the price data field 106 in the interface shown in FIG. 5B. Similarly, reviewing the text in the FSI advertisement of FIG. 5A, the user may note the regular price for the item ($199.99) and the amount off ($30) and enter this information into the appropriate data fields 108a, 108b in the interface shown in FIG. 5B. This process may continue until all of the relevant information has been entered about the item.

Alternatively, the user may also extract the advertisement text from the image shown in FIG. 5A, as described above, by, for example, enabling the Jade plug-in tool, and dragging the mouse over the desired portion of the text image that the user wishes to select and perform a conventional “cut” operation in which this information is copied to the Microsoft Windows clipboard. The user may then paste this information into the ad text box (FIG. 5B) by copying it from the Microsoft Windows clipboard. Other text data may also be pasted into the comments text box if desired.

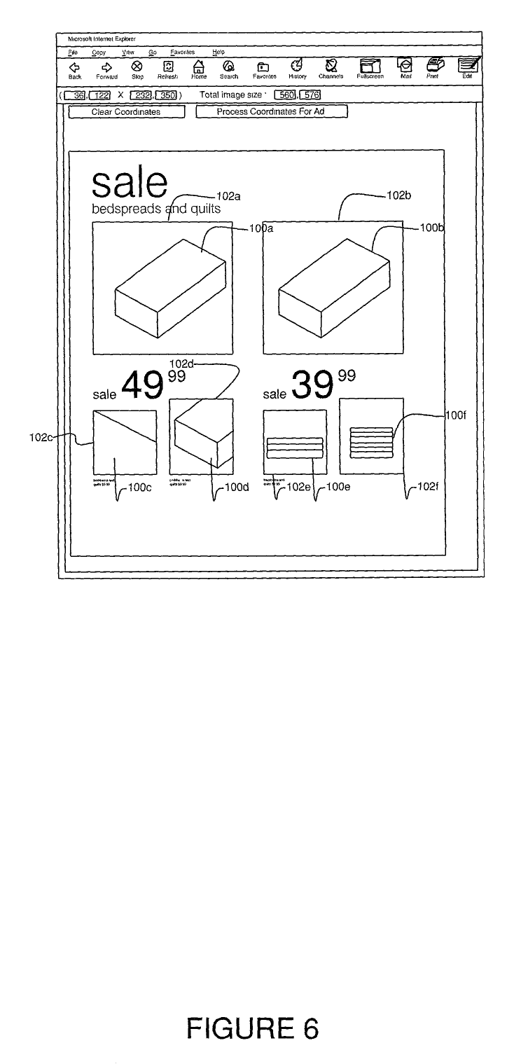

The user may also invoke an image mapping process with pre-print advertisement. For example, by selecting the “Image Mapper” hotlink 110 in the interface (FIG. 3B) a pop-up window may be displayed to the user showing a replica image of the pre-print advertisement shown in FIG. 5A. By interacting with the pop-up window, the user may click and drag the mouse, as described above, to select an area surrounding the appropriate items on the replica image. In the example screenshot shown in FIG. 6 illustrating bedspreads and quilts, six unique items 100a-f are illustrated. By clicking and dragging the mouse around each of the items 100a-f independently, the user may establish image map boundaries about those items 100a-f (shown as rectangular boxes 102a-f). The user may then elect to process coordinates for the advertisement at which point pixel coordinates identifying the location of those boundaries on the image are associated with the advertisement. As will be described below, these image mappings may be “hotlinked” and associated with information about each advertisement item that may be displayed to a user when the user accesses a website containing the advertisement and move a mouse pointer or other selection indicator about the advertisement image.

Once image processing of the FSI advertisement has been completed and all relevant information has been entered into the system 10, one or more webpages depicting the FSI advertisement data can be created as is well known in the art and the relevant data may be “hotlinked” to the respective image areas in accordance with the image map data described above. Those webpages can be accessed by a user accessing the Internet 14 and the user can search for particular advertisements that meet the user's desired search criteria. Since these FSI images are digitally integrated on the Internet 14, various retail logos, name brands, store locations, and the like, can be linked to products shown in the digital advertisement. These products, name brands, and store locations can individually be searched and navigated by a user to permit the user to locate particular advertisements.

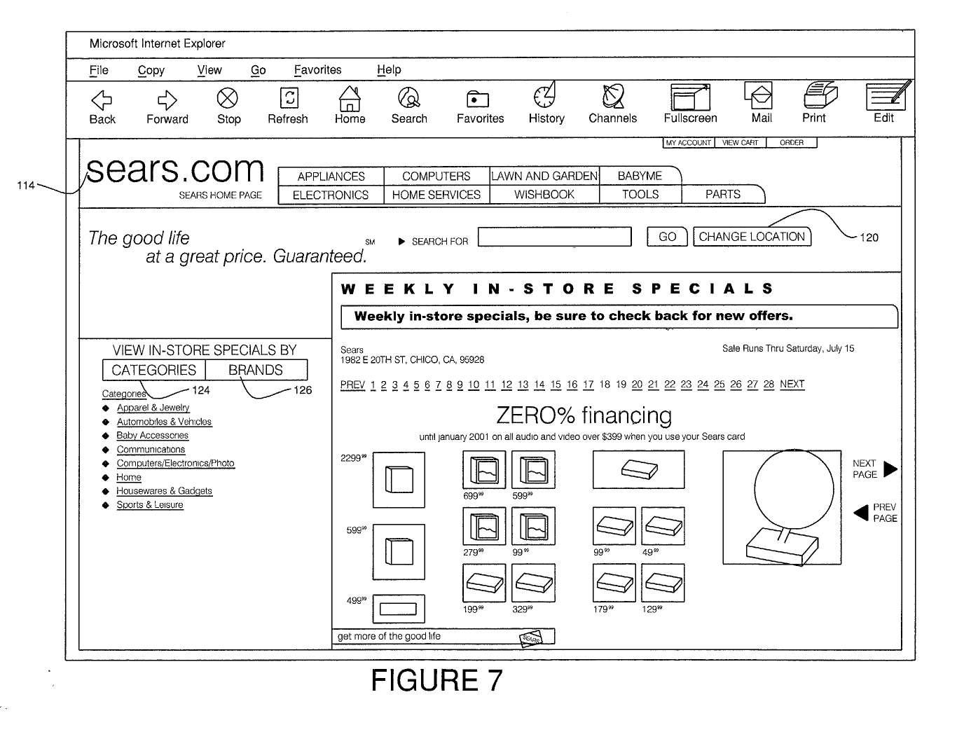

For example, in FIG. 7, an exemplary webpage that may be displayed to a user accessing the Internet 14 may allow the user to select a particular region (by selecting the “Location” button 120) for locating various advertisements. That way, a user can tailor a search to locate products that are offered in a particular location, such as near the user's residence. Geographical areas such as home, work and other preferred shopping areas can be included along with a selected radius within which shopping locations can be found. This very useful feature allows a user to shop within a selected geographical region and gather information including products, prices and other information before embarking on a shopping trip.

It may be important to a shopper to select a particular day for shopping that would be advantageous to the shopper. For example, special shopping deals, holiday prices, close-out sales and other events may entice a user to shop on a particular date. A shop date can be selected in order to limit an advertisement search (for example using a drop down menu or other selecting means to choose a particular date). Using this feature, a user can narrow down the shopping search and even plan a shopping trip for a future date.

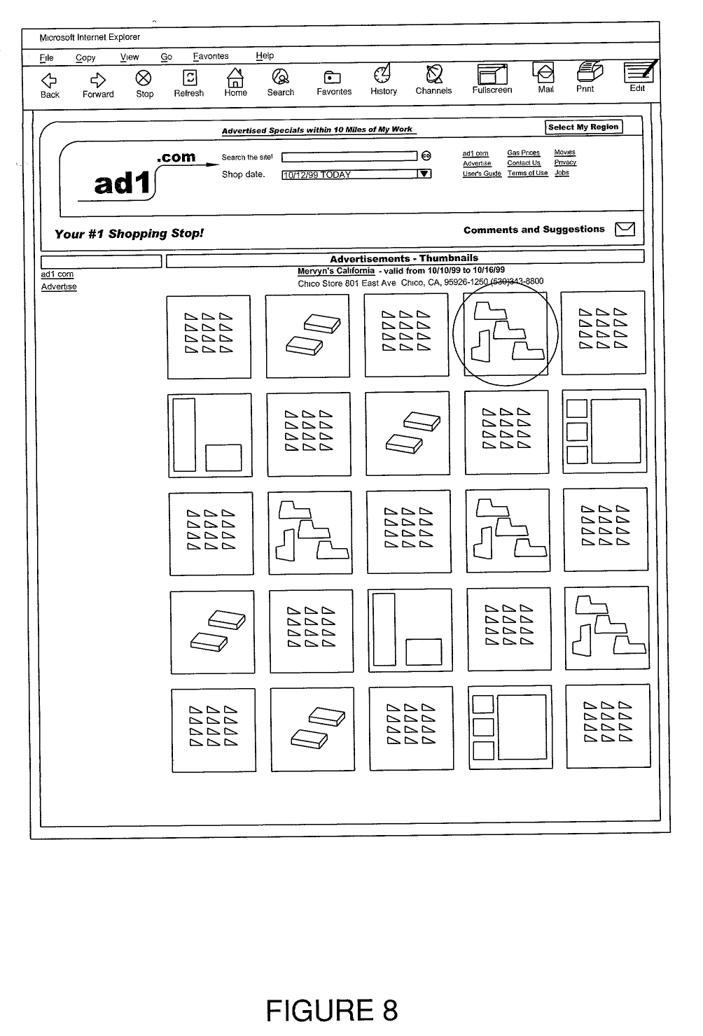

In one type of search, a user may, for example, select a particular store offering items by selecting a logo 114 associated with that store that is displayed on the page. In response to the user's selection, an advertisement webpage may be displayed to the user showing one or more products that are traditionally advertised in that store's FSIs. Advantageously, one or more of the pages of such an insert may be displayed (possibly as individually linked webpages). The individual pages (or thumbnail representations of the pages), may be selected by the user in order to expand the page and further display information about the product(s) being selected as described above. An example of this is shown in FIG. 8 which illustrates several thumbnail images 120 of digital FSI advertisements. Once an individual product is selected using these thumbnails, other information can be obtained. For example, a particular store, such as “Mervyn's California” may be selected. The advertisement in FIG. 8 shows that particular store and its location and phone number. Other webpages may be selected accordingly. They also may be navigated as is well known in the art, for example by using the “previous” and “next” links 122 to go back and forth among the various webpages of the free standing insert. By selecting a particular store, a user may also select to access that retailer's own website, for example by selecting an appropriate hyperlink 124 on the displayed webpage. The user may then navigate through the website of the retailer.

Referring again to FIG. 7, a user may also elect to search for various products by selecting the “Categories” tab 124. The “Categories” tab 124 may be used to select any number of products by a general product library. This library may be selected along with other related categories, for example, selecting a computer\electronics\photo products category may provide a list of various individual products related to these areas. Individual products can then be selected by the user for further review. Other categories may list other appropriate products.

The products may also be searched by brand names by selecting the “Brands” tab 126 shown in FIG. 7. Selecting the “Brands” tab 126 allows the user to select among a variety of brand names for products that may be searched by the user. Once a user selects a particular brand name, a list of products found under the brand name may be displayed to the user. Similar to that discussed above, individual products can then be selected by the user for further review.

Individual stores may also be searched for particular products allowing the user to select among a list of stores carrying a particular product. A list of sale items may be illustrated from the store selected along with a link to the FSI advertisement representation, the price and a retailer link. A user may then select individual products for further review.

The overall database 30 including all of the advertisements may also be searched using key words and phrases. This operates much like a conventional search engine used on the Internet 14. This searching feature allows a user to search by products, retailers or other information that may connect a user to a particular product or retailer.

The invention is directed to a method and apparatus for enabling advertising on a computer network in a manner that emulates a FSI traditionally used in newspaper advertising. Although this embodiment is described and illustrated in the context of a computer executable program configured to receive, store, cross reference and display product advertising information, its features may be useful in other applications where easy storage and processing of information is desired. Furthermore, while the foregoing description has been with reference to particular embodiments of the invention, it will be appreciated that these are only illustrative of the invention and that changes may be made to those embodiments without departing from the principles of the invention, the scope of which is defined by the spirit and scope of the this overall description.

What is claimed is:

1. An electronic system providing a plurality of digital free standing inserts, comprising:
an imaging application for receiving a pre-print free standing insert and for rendering a digital rendition of the pre-print free standing insert;
an advertisement creation application for capturing information relating to each of the advertisements depicted in the digital rendition of the pre-print free standing insert;
a database for storing the captured information;
an image server for rendering the captured information as one or more webpages, each webpage depicting a digital rendition of a particular pre-print free standing insert; and
a selection tool for allowing a user to locate particular ones of the digitally rendered pre-print free standing inserts.

2. The electronic system of claim 1, wherein the imaging application includes an embedded tool for selecting portions of the digitally rendered pre-print free standing insert.

3. The electronic system of claim 1, wherein the digitally rendered pre-print free standing inserts are locatable in accordance with geographic particularity.

4. The electronic system of claim 1, wherein a user can search among a plurality of digitally rendered free standing inserts to locate particular advertisements.

5. The electronic system of claim 4, wherein advertisements may be locatable in accordance with any of predefined product categories, brand categories, and store categories.

6. The electronic system of claim 1, wherein the digitally rendered pre-print free standing inserts are processed by an image mapping algorithm to create for each individual advertisement a hotspot area such that when a particular hotspot area is accessed by the user additional information relating to that associated advertisement is displayed to the user.

7. A method for creating a digital rendition of a pre-print free standing insert, comprising the steps of:
digitally rendering a pre-print free standing insert;
extracting individual graphic and text portions of the digitally rendered pre-print free standing insert, the graphic and text portions relating to individual advertisements on the pre-print free standing insert; and
performing an image mapping process on the digitally rendered pre-print free standing insert to associate a hotlink image boundary with respective advertisements on the digitally rendered pre-print free standing insert.

8. The method of claim 7, further comprising the steps of creating one or more webpages with the digitally rendered pre-print free standing insert and displaying the webpages to a user.

9. The method of claim 7, further comprising the step of associating additional information relating to each of the respective advertisements on the digitally rendered pre-print free standing insert, and presenting the additional information when the associated hotlink image boundary is accessed.
